(19) United States
(12) Patent Application Publication
(10) Pub. No.: US 2025/0211900 A1
(43) Pub. Date: Jun. 26, 2025

(54) METHOD, SYSTEM AND APPARATUS FOR DETERMINING POSITIONS OF SOUND DEVICES AND STORAGE MEDIUM THEREOF

(71) Applicant: HANSONG (NANJING) TECHNOLOGY LTD., Nanjing (CN)

(72) Inventors: Yang CHEN, Nanjing (CN); Yigao QIAO, Nanjing (CN); Yingbo PAN, Nanjing (CN); Wei CHEN, Nanjing (CN); Songxiang YANG, Nanjing (CN)

(73) Assignee: HANSONG (NANJING) TECHNOLOGY LTD., Nanjing (CN)

(21) Appl. No.: 19/075,751

(22) Filed: Mar. 10, 2025

Related U.S. Application Data
(63) Continuation of application No. PCT/CN2023/119014, filed on Sep. 15, 2023.

(30) Foreign Application Priority Data
Sep. 15, 2022 (CN) 202211130351.5

(51) Int. Cl. H04R 1/40; G01B 17/00

(52) U.S. Cl. CPC H04R 1/403; G01B 17/00; H04R 2201/405

(57) ABSTRACT

Disclosed is a method for determining positions of sound devices. The method comprises acquiring first position information corresponding to a plurality of point positions, a plurality of sound devices being disposed at the plurality of point positions; determining, based on signal transmitting and receiving data between the plurality of sound devices, second position information corresponding to the plurality sound devices; and determining, based on the first position information and the second position information, a position correspondence between the plurality of point positions and the plurality of sound devices.

### CROSS-REFERENCE TO RELATED APPLICATIONS

This application is a continuation of International Application No. PCT/CN2023/119014, filed on Sep. 15, 2023, which claims priority to Chinese Application No. 202211130351.5, filed on Sep. 15, 2022, the entire contents of which are incorporated herein by reference.

### TECHNICAL FIELD

The present disclosure relates to the field of equipment configuration and equipment layout, and in particular to a method, system, and apparatus for determining positions of sound devices and a storage medium thereof.

### BACKGROUND

Large venues such as shopping malls and schools need to be installed with sound devices. Usually, point positions for arranging the sound devices can be pre-designed on the design drawing of the venue according to the structure and area of the venue, such that the sound devices disposed at the corresponding point positions can be conveniently controlled in a point-to-point manner based on the design drawing. However, during the actual installation of the sound devices, the relevant installers may not install the corresponding numbered sound devices at the corresponding point positions as planned, or may forget or make errors during installation, which makes it impossible for managers to carry out accurate remote control of the sound devices at the corresponding point positions according to the design drawing. In addition, it is time-consuming to re-determine the correspondence between the point positions and the actual installed sound devices, especially when the count of the installed sound devices is large, the workload is large and the efficiency is low. When some sound devices are installed at a relatively high position, the difficulty of calibration is increased.

Therefore, it is desirable to provide a method and system for determining positions of sound devices, which can automatically realize the correspondence between the point positions on the design drawing and the actual installed sound devices, thereby reducing the cost of labor and time.

### SUMMARY

One or more embodiments of the present disclosure provide a method for determining positions of sound devices. The method may comprise: acquiring first position information corresponding to a plurality of point positions, a plurality of sound devices being disposed at the plurality of point positions; determining, based on signal transmitting and receiving data between the plurality of sound devices, second position information corresponding to the plurality sound devices; and determining, based on the first position information and the second position information, a position correspondence between the plurality of point positions and the plurality of sound devices.

One of the embodiments of the present disclosure provides a system for determining positions of sound devices. The system may comprise: an acquisition module configured to acquire first position information corresponding to a plurality of point positions, a plurality of sound devices being disposed at the plurality of point positions; a first determination module configured to determine, based on signal transmitting and receiving data between the plurality of sound devices, second position information corresponding to the plurality of sound devices; and a second determination module configured to determine, based on the first position information and the second position information, a position correspondence between the plurality of point positions and the plurality of sound devices.

One or more embodiments of the present disclosure provide an apparatus for determining positions of sound devices. The apparatus may comprise processor configured to execute the method for determining the positions of the sound devices described above.

One or more embodiments of the present disclosure provide a non-transitory computer-readable storage medium, comprising computer instructions that, when read by a computer, may direct the computer to execute the method for determining the positions of the sound devices described above.

### BRIEF DESCRIPTION OF THE DRAWINGS

The present disclosure will be further illustrated by way of exemplary embodiments, which will be described in detail by means of the accompanying drawings. These embodiments are not limiting, and in these embodiments, the same numbering indicates the same structure, wherein:

FIG. 1 is a schematic diagram illustrating an application scenario of a system for determining positions of sound devices according to some embodiments of the present disclosure;

FIG. 2 is a block diagram illustrating an exemplary system for determining positions of sound devices according to some embodiments of the present disclosure;

FIG. 3 is a flowchart illustrating an exemplary process for determining positions of sound devices according to some embodiments of the present disclosure;

FIG. 4 is flowchart illustrating an exemplary process for determining a position correspondence between a plurality of point positions and a plurality of sound devices according to some embodiments of the present disclosure;

FIG. 5 is a schematic diagram illustrating an exemplary process for determining first position information and second position information according to some embodiments of the present disclosure;

FIG. 6 is a schematic diagram illustrating an exemplary process for determining a test distance between two sound devices according to some embodiments of the present disclosure; and

FIG. 7 is flowchart illustrating an exemplary process for determining a position correspondence between a plurality of point positions and a plurality of sound devices according to some embodiments of the present disclosure.

### DETAILED DESCRIPTION

In order to more clearly illustrate the technical solutions of the embodiments of the present disclosure, the accompanying drawings required to be used in the description of the embodiments are briefly described below. Obviously, the accompanying drawings in the following description are only some examples or embodiments of the present disclosure, and it is possible for a person of ordinary skill in the art to apply the present disclosure to other similar scenarios in accordance with these drawings without creative labor. Unless obviously obtained from the context or the context illustrates otherwise, the same numeral in the drawings refers to the same structure or operation.

It should be understood that the terms “system,” “device,” “unit” and/or “module” used herein are a way to distinguish between different components, elements, parts, sections, or assemblies at different levels. However, the terms may be replaced by other expressions if other words accomplish the same purpose.

Unless the context clearly suggests an exception, the words “one,” “a,” “” “an,” “one kind,” and/or “the” do not refer specifically to the singular, but may also include the plural. Generally, the terms “including” and “comprising” suggest only the inclusion of clearly identified steps and elements, however, the steps and elements that do not constitute an exclusive list, and the method or apparatus may also include other steps or elements.

Flowcharts are used in the present disclosure to illustrate the operations performed by a system according to embodiments of the present disclosure, and the related descriptions are provided to aid in a better understanding of the magnetic resonance imaging method and/or system. It should be appreciated that the preceding or following operations are not necessarily performed in an exact sequence. Instead, steps can be processed in reverse order or simultaneously. Also, it is possible to add other operations to these processes or to remove a step or steps from these processes.

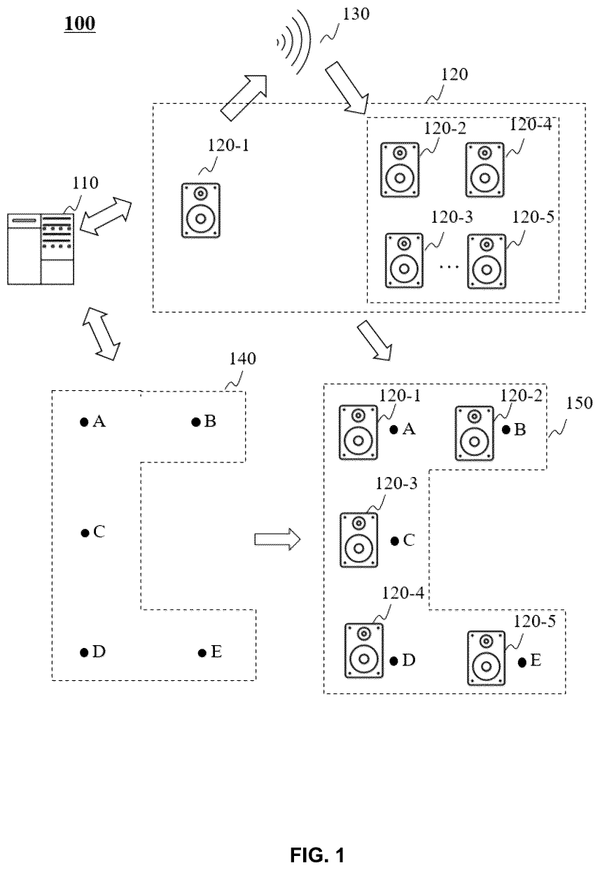

FIG. 1 is a schematic diagram illustrating an application scenario of a system for determining positions of sound devices according to some embodiments of the present disclosure. Determining the positions of sound devices refers to determining a one-to-one correspondence between the sound devices and point positions. In some embodiments, an application scenario 100 of a system for determining positions of sound devices may include a processing device 110, sound devices 120, a signal 130, and point positions 140.

The processing device 110 may be configured to process information and/or data related to the application scenario 100 of the system for determining the positions of the sound devices, such as position information of the sound devices, position information of the point positions, etc. In some embodiments, the processing device 110 may be a processing device of a user terminal. For example, the processing device 110 may be a central processing unit (CPU) of a desktop computer. In some embodiments, the processing device 110 may process data, information and/or processing results obtained from other devices or system components, and execute program instructions based on the data, information and/or processing results to perform one or more functions described in the present disclosure. For example, the processing device 110 may obtain signal information sent and received by the sound devices 120, and determine a position relationship between the sound devices 120 and the correspondence between the sound devices 120 and the point positions 140 based on the signal information.

The sound devices 120 refer to device for playing an audio. The sound devices 120 may include a plurality of types. For example, the sound devices 120 may be categorized as a main power amplifier sound device, a monitoring sound device, and a feedback sound device according to the purpose of the sound devices. As another example, the sound devices may be categorized as a full-band sound device, a bass sound device, and a sub-bass sound device according to a playback frequency. As another example, the sound devices may be categorized as a closed sound device, a bass reflex sound device, a transmission line sound device, etc. according to the box structure. Each of the sound devices 120 may include a plurality of components such as a power amplifier, a loudspeaker, a DVD, an equalizer, etc.

In some embodiments, the application scenario 100 may include the sound devices 120. The sound devices 120 may include one or more sound devices, such as a sound device 120-1, a sound device 120-2, a sound device 120-3, a sound device 120-4, a sound device 120-5, etc. as shown in FIG. 1. For example, various scenarios such as a conference room, a shopping mall, or a whole-home smart furniture system may include a plurality of sound devices, and the plurality of sound devices may be disposed at a plurality of positions.

In some embodiments, the sound devices 120 may receive data, information and/or instructions transmitted by the processing device 110. For example, the sound devices 120 may receive an instruction for sending a signal transmitted by the processing device 110, and send the signal according to the instruction. In some embodiments, the sound devices 120 may send information and/or data to the processing device 110. For example, the sound devices 120 may send information such as the positions information, a signal transmitting and receiving intensity, etc., to the processing device 110.

The signal 130 refers to a signal sent and received by the sound devices 120. The signal 130 may include sound wave signals, electromagnetic wave signals, and light wave signals of different frequencies. In some embodiments, the signal 130 may be configured to determine the position relationship between the sound devices 120, and then determine the correspondence between the sound devices 120 and the point positions 140. When the position relationship between the sound devices 120 is determined based on the signal 130, the signal 130 may be sent by a certain sound device and received by other sound devices. As shown in FIG. 1, the sound device 120-1 is a sound device that sends the signal 130, and the sound device 120-2, the sound device 120-3, the sound device 120-4, and the sound device 120-5 are sound devices that receive the signal 130. To determine the position relationship between the sound devices 120 based on the signal 130, the method to be used may be determined based on the specific form of the signal. For example, when the signal 130 is a sound wave signal, the processing device 110 may determine a distance between the sound device that sends the sound wave signal and the sound device that receives the sound wave signal using a sound wave ranging method.

The point positions 140 refer to designed installation positions of the sound devices 120. In some embodiments, the point positions where the sound devices need to be installed may be marked on a design drawing. The design drawing may be a floor plan, a graphic design plan, etc. The design drawing may include a plurality of point positions 140. The point positions 140 may be represented by numbers or letters. As shown in FIG. 1, the point positions 140 may include a point A, a point B, a point C, a point D, a point E, etc. In some embodiments, the processing device 110 may obtain information and/or data of the point positions 140. For example, the processing device 110 may obtain the position information of the point positions 140 through a drawing design application.

In some embodiments, the correspondence between the sound devices and the point positions 140 may be determined through the sound devices 120 and the point positions 140. In the application scenario, each point position may be provided with a sound device. As shown in FIG. 1, a diagram 150 illustrating comparison of point positions and sound devices represents the correspondence between the sound devices 120 and the point positions 140. For example, the sound device 120-1 corresponds to the position of point A, and the sound device 120-2 corresponds to the position of point B according to the diagram 150.

It should be noted that the application scenario is provided only for the purpose of illustration and is not intended to limit the scope of the present disclosure. For those having ordinary skills in the art, various modifications or changes can be made according to the description of the present disclosure. For example, the application scenario may include a database. As another example, the application scenario may be implemented on other devices to achieve similar or different functions. However, such changes and modifications will not deviate from the scope of the present disclosure.

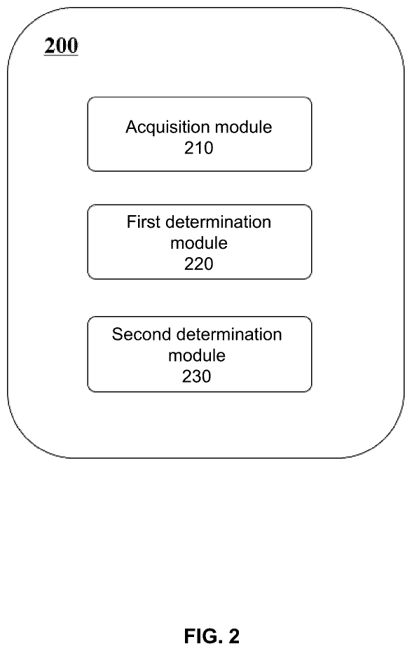

FIG. 2 is a block diagram illustrating an exemplary system for determining positions of sound devices according to some embodiments of the present disclosure. As shown in FIG. 2, a system 200 for determining positions of sound devices may include an acquisition module 210, a first determination module 220, and a second determination module 230.

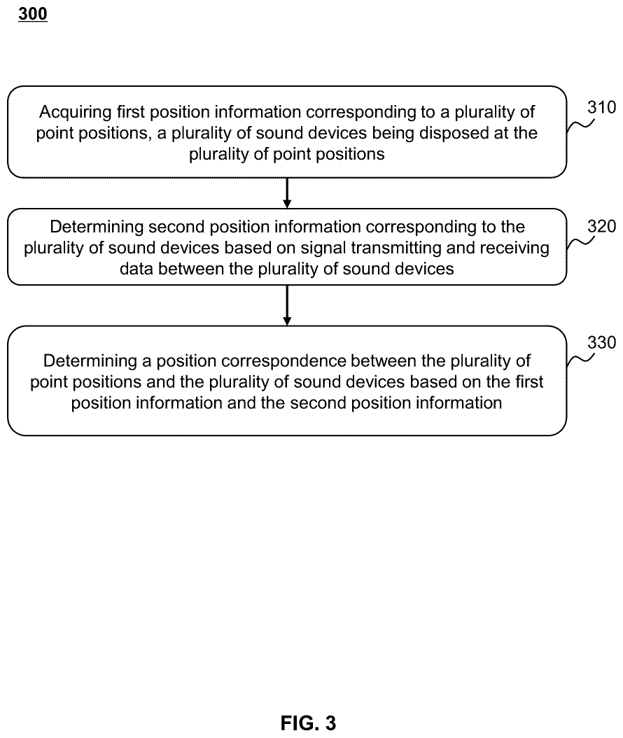

The acquisition module 210 may be configured to acquire first position information corresponding to a plurality of point positions, a plurality of sound devices being disposed at the plurality of point positions. More descriptions regarding acquiring the first position information may be found in FIG. 3 and the related descriptions thereof.

The first determination module 220 may be configured to determine, based on signal transmitting and receiving data between the plurality of sound devices, second position information corresponding to the plurality of sound devices.

In some embodiments, for any two sound devices of the plurality of sound devices, the first determination module 220 may be further configured to determine, based on a receiving intensity of a signal sent by one of the two sound devices to the other sound device, a test distance between the two sound devices as the second position information.

In some embodiments, the first determination module 220 may be further configured to cause a first device to transmit sound waves of a plurality of frequencies; and determine, based on a receiving intensity of the sound waves of the plurality of frequencies, the test distance using a second device.

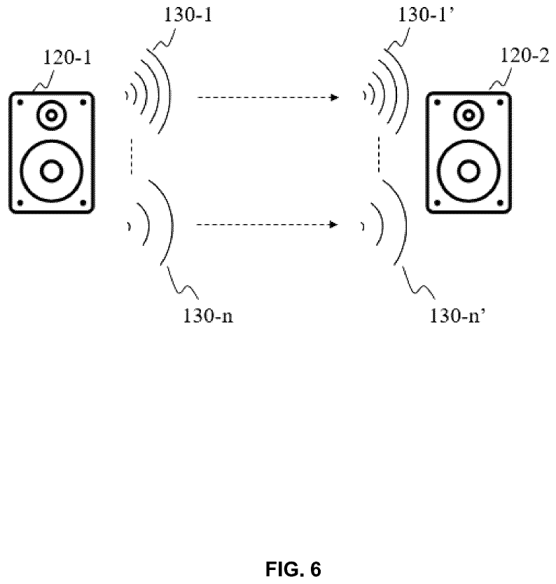

More descriptions regarding determining the second position information may be found in FIG. 3 and the related descriptions thereof. More descriptions regarding determining the test distance may be found in FIG. 6 and the related descriptions thereof.

The second determination module 230 may be configured to determine a position correspondence between the plurality of point positions and the plurality of sound devices based on the first position information and the second position information.

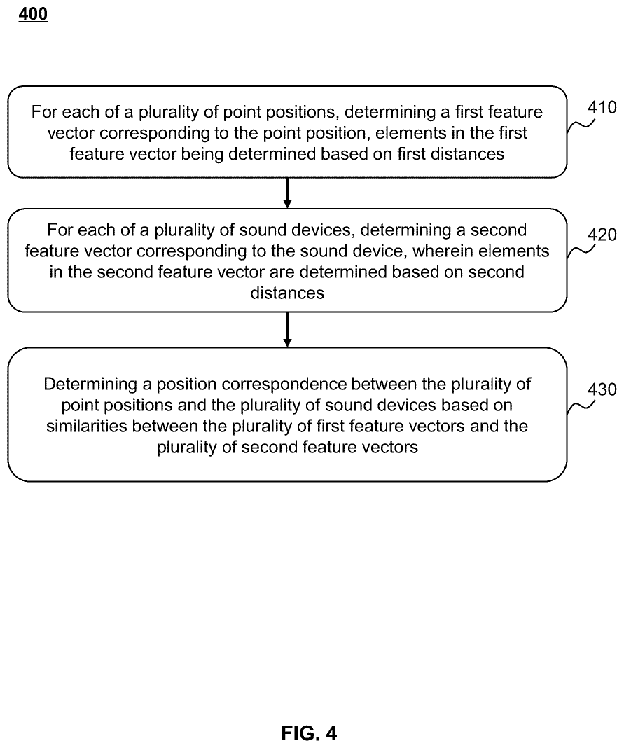

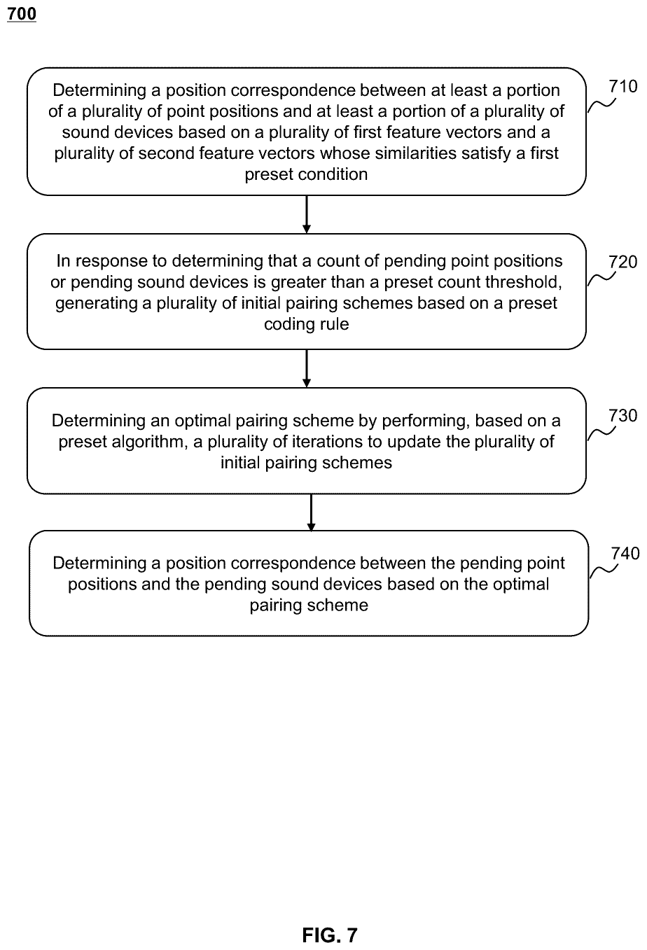

In some embodiments, the second determination module 230 may be further configured to determine, for each of the plurality of point positions, a first feature vector corresponding to the point position, elements in the first feature vector being determined based on first distances; determine, for each of the plurality of sound devices, a second feature vector corresponding to the sound device, wherein elements in the second feature vector may be determined based on second distances; and determine, based on similarities between the plurality of first feature vectors and the plurality of second feature vectors, the position correspondence between the plurality of point positions and the plurality of sound devices. More descriptions regarding determining the position correspondence may be found in FIG. 3, FIG. 4 and FIG. 7 and the related descriptions thereof.

FIG. 3 is a flowchart illustrating an exemplary process for determining positions of sound devices according to some embodiments of the present disclosure. As shown in FIG. 3, a process 300 may include the following operations.

In 310, first position information corresponding to a plurality of point positions may be acquired, a plurality of sound devices being disposed at the plurality of point positions. In some embodiments, the operation 310 may be performed by the acquisition module 210.

The point positions refer to installation positions of the sound devices. The point positions where the sound devices are to be mounted may be marked in a design drawing of the sound devices. More descriptions regarding the point positions may be found in FIG. 1 and the related descriptions thereof. In some embodiments, the design drawing may include a plurality of point positions, and the plurality of sound devices may be disposed at the plurality of point positions. For example, each of the point positions may be provided with one of the sound devices.

The sound devices refer to devices disposed at the point positions for audio playback. More descriptions regarding the sound devices may be found in FIG. 1 and the related descriptions thereof.

The first position information refers to information related to the position of each point position. For example, position information of each point position may be obtained based on the design drawing as the first position information. In some embodiments, the first position information may include: the position information of each point position, a position relationship between the point positions, etc.

In some embodiments, the position information of each point position may be represented by coordinates, or by a position relationship with a fixed first reference object. The position relationship between the point positions may be represented by an orientation, a distance, etc. For example, a relative position relationship of a point position A relative to a point position B may include that the point position A is located 30° north of the point position B. A relative position relationship of the point position A to a point position C may include that a relative distance between the point position A and the point position C is 3.5 cm, etc.

In some embodiments, the position information of each point position in the first position information may be represented by a parameter vector. For example, a vector \vec{n}=(e, f, g . . . ) may be constructed, where each element may represent the position information of a point position.

In some embodiments, when the first position information includes the relative position relationship between the point positions, the first position information may correspond to the point positions in a one-to-one manner. The first position information corresponding to one of the point positions may include a relative position relationship between the point position and other point positions. The first position information corresponding to the point position may be represented by a vector. For example, a vector \vec{n}=(h, i, j, . . . ) may be constructed, where each element represents the relative position relationship (e.g., the distance or the orientation, etc.) between the point position and other point positions.

In some embodiments, the relative position relationship between the point positions may include a plurality of first distances corresponding to each point position.

The first distances corresponding to each point position refer to relative distances between the point position and other point positions. In some embodiments, the relative distances between each point position and other point positions may be relative distances obtained based on the design drawing, or a relative distance between two point positions actually measured.

In some embodiments, the relative distance may include straight-line distance between two point positions. For example, if the straight-line distance between the two points is 5 cm as measured based on the design drawing, 5 cm is taken as the relative distance between the two point positions.

Taking the point position A, the point position B, and the point position C of the plurality of point positions listed in FIG. 1 as an example, the first position information of the point position A includes a plurality of first distances corresponding to the point position A. The plurality of first distances corresponding to the point position A may include a relative distance between the point position A and the point position B, and a relative distance between the point position A and the point position C, respectively. For example, the relative distance between the point position A and the point position B, and the relative distance between the point position A and the point position C are 3 cm and 4 cm, respectively, and the plurality of first distances corresponding to the point position A are 3 cm and 4 cm.

In some embodiments, the first position information may be determined based on the design drawing.

For example, when the first position information is the position information of the point positions, the acquisition module 210 may determine the position information of each point position based on coordinates of each point position in the design drawing (a coordinate system may be constructed based on the design drawing). Merely by way of example, the acquisition module 210 may determine coordinate information of each point position based on the coordinate system of the design drawing, and take the determined coordinate information of each point position as the first position information corresponding to each point position.

As another example, when the first position information is the position relationship between the point positions, the acquisition module 210 may determine the position information of each point position based on the relative position relationship between each point position and other point positions on the design drawing. Merely by way of example, the acquisition module 210 may obtain information such as a distance and an angle between the point positions on the design drawing by manual measurement or software distance measurement. For example, as for the point position A, the point position B, and the point position C shown in FIG. 1, based on manual measurement, the first position information of the point position A includes that the distance between the point position A and the point position B is 3 cm, and the point position A is located due west of the point position B; the distance between the point position A and the point position C is 4 cm, and the point position A is located due north of the point position C. The distance between the point position A and the point position B and the distance between the point position A and the point position C may be directly expressed as a vector (3, 4).

In 320, second position information corresponding to the plurality of sound devices may be determined based on signal transmitting and receiving data between the plurality of sound devices. In some embodiments, the operation 320 may be performed by the first determination module 220.

The sound devices are capable of sending and receiving signals. When one of the sound devices sends a signal, other sound devices can receive the signal sent by the sound device. Data generated during a signal transmitting and receiving process is the signal transmitting and receiving data. The signal transmitting and receiving data may include signal sending data and signal receiving data.

In some embodiments, the signal sending data may include a signal sending time, a sound device sending the signal, a signal intensity at the time of sending, etc., and the signal receiving data may include a signal receiving time, a sound device receiving the signal, a signal intensity at the time of receiving, etc. For example, the signal sending data includes that the signal sending time is 09:00 am, the sound device sending the signal is a sound device 0001, the signal intensity at the time of sending is 30 decibels, etc. As another example, the signal receiving data may include that the signal receiving time is 09:01 am, the sound device receiving the signal is a sound device 0002, the signal intensity at the time of receiving is 25 decibels, etc. In some embodiments, the first determination module 220 may obtain the signal sending data from the sound device sending the signal, and obtain the signal receiving data from the sound device receiving the signal. For example, the first determination module 220 obtains a volume setting of the sound device sending the signal when the sound device plays an audio as the signal intensity at the time of sending in the signal transmitting and receiving data, obtains a playback time recorded by the sound device sending the signal as the signal sending time in the signal transmitting and receiving data, etc. As another example, the first determination module 220 obtains a signal receiving time recorded by the sound device receiving the signal as the signal receiving time in the signal transmitting and receiving data, and obtains a monitoring volume of the sound device receiving the signal as the signal intensity at the time of receiving in the signal transmitting and receiving data. The first determination module 220 may obtain the signal transmitting and receiving data in other ways. For example, the first determination module 220 may obtain the signal transmitting and receiving data input by a user terminal.

The second position information refers to actual installation position information corresponding to each sound device. In some embodiments, the second position information may include positioning information of each sound device, a relative position relationship between the sound devices, etc.

In some embodiments, the positioning information of each sound device may be represented by coordinates, or by a position relationship with a fixed second reference object. The relative position relationship between the sound devices may be represented by an orientation, an angle value, etc. For example, the positioning information of the sound device 120-1 may include that the sound device 120-1 is located on the left side of a TV set with a relative distance of 0.5 m; and the relative position relationship between the sound device 120-1 and the sound device 120-3 may include that the sound device 120-1 is located 1 m in front of the sound device 120-3.

In some embodiments, the positioning information of each sound device in the second position information may be represented by a parameter vector. For example, a vector \vec{m}=(a, b, c, . . . ) may be constructed, where each element may represent the positioning information of a sound device.

In some embodiments, when the second position information includes the relative position relationship between the sound devices, the second position information may correspond to the sound devices in a one-to-one manner, and the second position information corresponding to one of the sound devices may include the relative position relationship between the sound device and other sound devices. The second position information corresponding to the sound device may be represented by a vector. For example, a vector \vec{m}=(d, e, f, . . . ) may be constructed, where each element may represent the relative position relationship (e.g., the distance or the orientation, etc.) between the sound device and other sound devices.

In some embodiments, the relative position relationship between the sound devices may include a plurality of second distances corresponding to each sound device.

The second distances are test distances between the sound devices determined based on an actual installation space.

The test distances refer to relative distances between the sound devices in the actual installation space. The test distances may include a straight-line distance between two sound devices. For example, if an actual straight-line distance between the two sound devices is 2 m through measurement, 2 m is taken as the test distance between the two sound devices.

Taking the sound device 120-1, the sound device 120-2, and the sound device 120-3 among the plurality of sound devices in FIG. 1 as an example, the second position information of the sound device 120-1 includes a plurality of second distances corresponding to the sound device 120-1. The plurality of second distances corresponding to the sound device 120-1 may include a test distance between the sound device 120-1 and the sound device 120-2, and a test distance between the sound device 120-1 and the sound device 120-3, respectively, determined based on the actual installation space. For example, the test distance between the sound device 120-1 and the sound device 120-2 and the test distance between the sound device 120-1 and the sound device 120-3 are 3 m and 4.1 m, respectively, and the plurality of second distances corresponding to the sound device 120-1 are 3 m and 4.1 m.

In some embodiments, the second distances may be measured in various manners, such as manual measurement, infrared ranging, etc. In some embodiments, the second distance may be determined based on the signal transmitting and receiving data between the sound devices. More descriptions regarding determining the second distances based on the signal transmitting and receiving data may be found in the descriptions regarding determining the test distances and the related descriptions of FIG. 6.

In some embodiments, the second position information may be determined based on the signal transmitting and receiving data between the plurality of sound devices.

In some embodiments, the first determination module 220 may determine the second position information based on signal intensity difference data obtained based on the signal transmitting and receiving data. The signal intensity difference data refers to a difference between an intensity of the signal sent by a signal sending device and an intensity of the signal received by a signal receiving device. For example, a distance corresponding to the signal intensity difference data is determined based on a preset first comparison table and the signal intensity difference data obtained based on the signal transmitting and receiving data. The first comparison table may include reference signal intensity difference data and reference distances corresponding to the reference signal intensity difference data.

In some embodiments, the first determination module 220 may determine the second position information based on a time difference between a signal sending time and a signal receiving time. For example, a test distance between the signal sending device and the signal receiving device may be determined by calculating a time difference between a time when the signal sending device sends the signal and a time when the signal receiving device receives the signal in combination with a propagation speed of the signal.

In some embodiments, for any two sound devices among the plurality of sound devices, the first determination module 220 may determine a test distance between the two sound devices as the second position information based on a receiving intensity of a signal sent by one of the two sound devices to the other sound device. For example, the test distance may be determined as the second position information based on a second comparison table including a correspondence between reference receiving intensities and reference distances. More descriptions regarding determining the test distance based on the receiving intensity of the signal may be found in FIG. 6 and the related descriptions thereof.

The second position information is determined based on the receiving intensity of the signal, which extends methods for determining the second position information, thereby making it easier for users to select a suitable solution for operation. Meanwhile, large errors in manual measurement can be avoided, making the obtained second position information more accurate.

In 330, a position correspondence between the plurality of point positions and the plurality of sound devices may be determined based on the first position information and the second position information. In some embodiments, the operation 330 may be performed by the second determination module 230.

The position correspondence refers to a comparison relationship between the point positions and the sound devices. In some embodiments, the second determination module 230 may determine a correspondence relationship between a point position and a sound device based on a similarity between the first position information corresponding to the point position and the second position information corresponding to the sound device; in response to determining that the similarity satisfies preset requirements, determine that the point position and the sound device have the position correspondence. The preset requirements may include that the similarity is not less than a preset similarity threshold or the similarity is the highest similarity.

In some embodiments, the similarity between the first position information and the second position information may include a similarity of data such as, the distance, the angle, etc.

In some embodiments, the position correspondence between the plurality of point positions and the plurality of sound devices may be determined based on the first position information and the second position information.

Taking the point positions and the sound devices in FIG. 1 mentioned in operation 310 and operation 320 as an example, the first position information of the point position A obtained based on the relative distance between the point position A and the point position B and the relative distance between the point position A and the point position C is (3, 4), the first position information of the point position B obtained based on the relative distance between the point position B and the point position A and the relative distance between the point position B and the point position C is (3, 5), and the first position information of the point position C obtained based on the relative distance between the point position C and the point position A and the relative distance between the point position C and the point position B is (4, 5). The second position information of the sound device 120-1 obtained based on the test distance between the sound device 120-1 and the sound device 120-2 and the test distance between the sound device 120-1 and the sound device 120-3 is (3, 4.1), the second position information of the sound device 120-2 obtained based on the test distance between the sound device 120-2 and the sound device 120-1 and the test distance between the sound device 120-2 and the sound device 120-3 is (3, 4.9), and the second position information of the sound device 120-3 obtained based on the test distance between the sound device 120-3 and the sound device 120-1 and the test distance between the sound device 120-3 and the sound device sound device 120-2 is (4.1, 4.9). According to the first position information of the three point positions and the second position information of the three sound devices, the distance information of the point position A is closest to the distance information of the sound device 120-1, i.e., the similarity is the highest, thus the point position A and the sound device 120-1 have a position correspondence. Similarly, the point position B and the sound device 120-2, and the point position C and the sound device 120-3 have the position correspondence, respectively.

In some embodiments, the second determination module 230 may construct feature vectors of the point positions and the sound devices, and then determine the position correspondence by calculating vector similarity. As in the above example, feature vectors of the first position information of the three point positions and feature vectors of the second position information of the three sound devices are constructed, respectively, wherein the vector similarity between the point position A and the sound device 120-1 is the highest based on the calculation of the vector similarity, thus the point position A and the sound device 120-1 have the position correspondence. More descriptions regarding determining the position correspondence based on the feature vector may be found in the related descriptions of FIG. 4.

In some embodiments of the present disclosure, by determining the first position information of the point positions and the second position information of the sound devices, and then determining the position correspondence, the position correspondence between the point positions and the sound devices can be accurately and quantitatively determined. In such cases, even if the device numbers are not matched one-to-one with the installation point positions during the installation process, the sound devices and the point positions can be automatically matched, thereby realizing remote management and precise control of the sound devices based on the point positions.

In some embodiments of the present disclosure, the plurality of first distances between the point position and other point positions are determined as the first position information, and the plurality of second distances between the sound device and other sound devices are determined as the second position information, such that the position information of the point positions and the sound devices determined based on a plurality of distance data is more accurate, thereby facilitating accurate and rapid determination of the position correspondence between the point positions and the sound devices.

FIG. 4 is flowchart illustrating an exemplary process for determining a position correspondence between a plurality of point positions and a plurality of sound devices according to some embodiments of the present disclosure.

In some embodiments, a process 400 may include the following operations, and the process 400 may be performed by the second determination module 230.

In 410, for each of a plurality of point positions, a first feature vector corresponding to the point position may be determined, elements in the first feature vector being determined based on first distances.

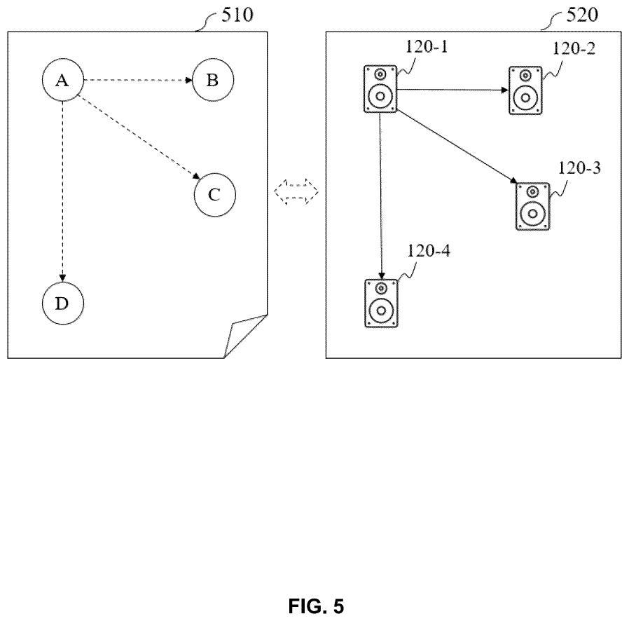

The first feature vector refers to a vector generated based on relative distances between each point position and a plurality of other point positions on a design drawing. In some embodiments, one point position may correspond to one first feature vector, and one first feature vector may correspond to one point position. As shown in FIG. 5, four point positions A, B, C, and D (other point positions are not shown) are preset on a design drawing 510 (e.g., a floor plan). For the point position A, the relative distances between the point position A and the point positions B, C, and D may be obtained based on the design drawing 510, and the first feature vector corresponding to the point position A may be generated based on each relative distance.

In some embodiments, each element in the first feature vector may be determined based on a first distance between the corresponding point position and any other point position. For example, the first distance may be configured to characterize the relative distance between a point position and any other point position on the design drawing. More descriptions regarding the first distance may be found in FIG. 3.

A count of the elements in the first feature vector may be determined based on a total count of point positions or a first preset value. For example, if the total count of point positions is 20, the first distances between a target point position and other 19 point positions may be obtained, and the first feature vector may be determined. The first preset value may be the count of the elements in the first feature vector preset based on various rules (e.g., in proportion to the total count). For example, when the first preset value is 3, the first distances between the target point position and three points closest to the target point position may be obtained, and the first feature vector may be determined.

FIG. 5 is a schematic diagram illustrating an exemplary process for determining first position information and second position information according to some embodiments of the present disclosure. The design drawing 510 is a schematic diagram illustrating pre-designed installation points of the sound devices, and an actual arrangement 520 is a schematic diagram illustrating an arrangement of the sound devices in a physical place (e.g., a shopping mall, an office region, etc. corresponding to the design drawing). The design drawing 510 may include a plurality of preset point positions (e.g., the point positions A, B, C, D, etc.), and the actual arrangement 520 may include a plurality of sound devices (e.g., the sound device 120-1, 120-2, 120-3, 120-4, etc.) arranged with reference to the plurality of point positions on the design drawing.

As shown in FIG. 5, the first distances between the point position A and the point positions B, C, and D on the design drawing 510 may be obtained, respectively, and the first feature vectors corresponding to the point position A, the point position B, the point position C, and the point position D may be further determined, respectively. For example, the first feature vectors corresponding to the point positions A, B, C, and D are (1, 1.5, 2), (1, 1.2, 2.2), (1.5, 1.2, 1.8), and (2, 2.2, 1.8), respectively. Taking the first feature vector corresponding to the point position A as an example, the values of the three elements correspond to the first distance between the point position A and the point position B, the first distance between the point position A and the point position C, and the first distance between the point position A and the point position D, respectively.

The values of the elements in the first feature vector may be scaled up or down based on a same preset multiple. For example, the value of the first element is 1, which may correspond to an actual distance of 10 cm, and after being scaled down by a multiple of 10, the value of the first element is 1. The same applies to the values of other elements. It can be understood that the processed first feature vectors facilitate subsequent calculation.

In 420, for each of a plurality of sound devices, a second feature vector corresponding to the sound device may be determined, wherein elements in the second feature vector are determined based on second distances.

The second feature vector refers to a vector generated based on an actual relative distance between each actual arranged sound device and other sound devices.

In some embodiments, each element in the second feature vector may be determined based on a second distance between the corresponding sound device and any other sound device. The second distance may be configured to characterize a test distance between an actual arranged sound device and any other sound device. More descriptions regarding the second distance may be found in FIG. 3.

In some embodiments, a count of the elements in the second feature vector may be the same as the count of the elements in the first feature vector. For example, the count of the elements in the second feature vector may be determined based on the first preset value. For example, when the first preset value is 3, the second distances between a target device and three devices closest to the target device may be obtained, and the second feature vector may be determined.

Similar to the first feature vector, the elements in the second feature vector may be scaled up or down based on the same preset multiple.

In some embodiments, the second feature vector corresponding to each sound device may be determined based on actual arrangement positions of the plurality of sound devices.

As shown in FIG. 5, four sound devices 120-1, 120-2, 120-3, and 120-4 (other sound devices are not shown) are actually arranged in the actual arrangement 520. For the sound device 120-1, the second distances between the sound device 120-1 and the sound devices 120-2, 120-3, and 120-4 are obtained, respectively, and the second feature vector corresponding to the sound device 120-1 is generated based on each relative distance. For example, the second feature vector (1, 1.51, 2.1) corresponding to the sound device 120-1 is determined, where the first element 1 represents the second distance between the device 120-1 and the device 120-2, the second element 1.51 represents the second distance between the sound device 120-1 and the sound device 120-3, and the third element 2.1 represents the second distance between the sound device 120-1 and the sound device 120-4. Similarly, for the sound devices 120-2, 120-3, and 120-4, the second feature vectors corresponding to the three sound devices may be determined respectively. For example, the second feature vectors corresponding to the sound device 120-2, the sound device 120-3, and the sound device 120-4 are (1.1, 1.22, 2.3), (1.54, 1.25, 1.8), and (2, 2.2, 1.85), respectively.

In some embodiments, the elements in a plurality of first feature vectors corresponding to the plurality of point positions and the elements in a plurality of second feature vectors corresponding to the plurality of sound devices may be arranged in the same manner.

The arrangement refers to various preset arrangement manners, such as an ascending arrangement, a descending arrangement, etc. For example, the elements in the plurality of first feature vectors and the elements in the plurality of second feature vectors may be arranged in an ascending order.

As shown in FIG. 5, the first feature vectors corresponding to the four point positions A, B, C, and D are (1, 1.5, 2), (1, 1.2, 2.2), (1.2, 1.5, 1.8), and (2, 1.8, 2.2), and the second feature vectors corresponding to the four sound devices 120-1, 120-2, 120-3, and 120-4 are (1, 1.51, 2.1), (1.1, 1.22, 2.3), (1.25, 1.54, 1.8), and (1.85, 2, 2.2).

It should be noted that the same arrangement of the elements in the plurality of first feature vectors and the elements in the plurality of second feature vectors can make subsequent calculation more convenient. Meanwhile, the same arrangement can make it easier for correspondence between the first feature vectors and the second feature vectors when the similarities between the plurality of first feature vectors and the plurality of second feature vectors are calculated. For example, the same scaling can also be performed based on the elements in the plurality of first feature vectors and the elements in the plurality of second feature vectors, which is not limited in the present disclosure.

In 430, a position correspondence between the plurality of point positions and the plurality of sound devices may be determined based on similarities between the plurality of first feature vectors and the plurality of second feature vectors.

The similarity refers to a degree of similarity between a first feature vector and a second feature vector. The similarity may be represented by a numerical value, such as a value in an interval of [0, 1], where the larger the numerical value, the greater the similarity. In some embodiments, the similarity may be determined based on various vector distance algorithms, such as a Euclidean distance, a cosine distance, etc. The smaller the vector distance between the first feature vector and the second feature vector, the greater the similarity. For example, when the vector distance is 0, it indicates that the two vectors are completely identical.

The sound devices corresponding to the point positions may be determined based on the position correspondence between the plurality of point positions and the plurality of sound devices. It should be noted that users (e.g., managers) can control the actual arranged sound devices based on the correspondence between the point positions on the design drawing and the actual arranged sound devices. For example, each sound device may be provided with a unique identifier (e.g., a device number). When it needs to control the sound device corresponding to the point position A to play music, a control instruction for playing music can be sent to the sound device (e.g., a sound device 001) arranged at the point position A to achieve remote control of the sound device.

In some embodiments, the vector distance between each of the plurality of first feature vectors and each of the plurality of second feature vectors may be calculated so as to obtain a plurality of vector distances.

As shown in FIG. 5, for the first feature vector corresponding to the point position A, four vector distance may be obtained by calculating the vector distances between the first feature vector corresponding to the point position A and the second feature vectors corresponding to four sound devices. Furthermore, the correspondence between the point position A and the actual arranged sound device may be determined based on a minimum value of the four vector distances of the point position A. For example, the vector distances between the first feature vector (1, 1.5, 2) corresponding to the point position A and the second feature vectors (1, 1.51, 2.1), (1.1, 1.22, 2.3), (1.25, 1.54, 1.8), and (2, 1.85, 2.2) corresponding to the sound devices 120-1, 120-2, 120-3, and 120-4 are calculated, respectively, where the vector distance between the first feature vector corresponding to the point position A and the second feature vector (1, 1.51, 2.1) presents a minimum value, and the second feature vector corresponds to the sound device 120-1, which indicates that the sound device corresponding to the point position A is the sound device 120-1. The same applies to other point positions. The correspondence between the point position A and the actual arranged sound devices may be determined based on the similarity between the first feature vector and the second feature vector.

In some embodiments, when the similarities between the plurality of first feature vectors and the plurality of second feature vectors are determined, in response to determining that the plurality of similarities are the same or less than a preset similarity threshold, the position correspondence between the plurality of point positions and the plurality of sound devices may be manually determined or modified. For example, when the similarity between the first feature vector corresponding to the point position A and the second feature vector corresponding to the sound device 120-1 and the similarity between the first feature vector corresponding to the point position A and the second feature vector corresponding to the sound device 120-2 are the same, whether the sound device corresponding to the point position A is the sound device 120-1 (e.g., a sound device 1) or the sound device 120-2 (e.g., a sound device 2) cannot be determined. In this case, manual determination may be adopted. For example, a control instruction for playing music may be sent to a sound device with a corresponding number (e.g., the sound device 120-1 or the sound device 120-2) through a control device (e.g., App) to obtain the sound device that plays music and an actual arrangement position of the sound device, and determine the correspondence between the sound device and the corresponding point position with reference to the design drawing 510.

In some embodiments, the correspondence between a plurality of point positions and a plurality of sound devices whose correspondence is not determined may be determined based on a preset algorithm. More descriptions regarding the preset algorithm may be found in FIG. 7 and the related descriptions thereof.

In some embodiments of present disclosure, the correspondence between the plurality of point positions and the plurality of sound devices is determined based on the similarities between the plurality of first feature vectors and the plurality of second feature vectors, so as to achieve the matching of the point positions and the actual arranged sound devices, thereby reducing the manpower and time consumption of manual inspection and matching. In addition, the calculation of the vector similarity is introduced, and the measurement error of the first distances and/or the second distances is considered, such that the matching process is more in line with the actual situation.

FIG. 6 is a schematic diagram illustrating an exemplary process for determining a test distance between two sound devices according to some embodiments of the present disclosure.

In some embodiments, the second determination module 230 may take a sound device that sends a signal as a first device, and a sound device that receives the signal as a second device. The signal may include sound waves of a plurality of frequencies. For any two sound devices of a plurality of sound devices, the determining, based on a receiving intensity of a signal sent by one of the two sound devices to the other sound device, a test distance between the two sound devices may include: causing the first device to transmit the sound waves of the plurality of frequencies; and determining, based on the receiving intensity of the sound waves of the plurality of frequencies, the test distance using the second equipment.

As shown in FIG. 6, the sound device 120-1 may be taken as the first device to send the signal. The signal sent by the first device may include one or more signals. For example, the signal sent by the first device may be one or more of signals 130-1-130-n. One or more of the remaining sound devices (e.g., the sound device 120-2) may be taken as the second device to receive the signal. Correspondingly, the second device may receive one or more signals sent by the first device. For example, the signal received by the second device may include one or more of signals 130-1′-130-n′.

The signal may include a light signal, a sound signal, an electrical signal, etc. In some embodiments, the signal sent by the first device may include the sound waves of the plurality of frequencies. As shown in FIG. 6, the signal 130-1 may be a soprano sound wave of 250 Hz, and the signal 130-n may be a sound wave of another frequency (e.g., a contralto of 123 Hz, or a bass of 90 Hz). The sound device 120-1 may play one or more segments of audio data preset in the sound device to obtain the sound waves of the plurality of frequencies.

The receiving intensity refers to an intensity of the signal received by the second device (i.e., an intensity degree of the signal). The receiving intensity may be represented in various forms, such as an intensity level, an intensity value, or the like.

In some embodiments, the test distance may be determined based on the intensity of the signal received by the second device. As shown in FIG. 6, the second device 120-2 may receive the signals 130-1 and 130-n sent by the first device 120-1, and determine a relative distance between the sound device 120-1 and the sound device 120-2 based on the intensity of the received signals 130-1′ and 130-n′.

In some embodiments, the test distance may be determined based on a signal type (e.g., an electromagnetic wave, or a sound wave), a signal parameter (e.g., a power, a frequency, or decibel), a relationship between a propagation distance of the signal and a signal attenuation, and an intensity of the signal finally received by the second device. For example, the test distance may be determined based on a reference relationship table generated by an algorithm and/or experimental data.

In some embodiments, the first device may emit the sound waves of the plurality of frequencies, and the second device may determine the test distance between the first device and the second device based on the receiving intensity of the sound waves of the plurality of frequencies. For example, the first device may play a plurality segments of audio data such as a soprano, a baritone, a bass, etc., respectively, and the second device may determine a plurality of test distances based on the intensity of the sound signals received, and perform calibration (e.g., verify the validity, calculate an average value, etc.) based on the plurality of test distances to determine the final test distance.

In some embodiments, the signal may include a laser beams, a millimeter wave, etc. It is understood that different signal types may correspond to different distance measurement processes or the test distances may be determined based on different characteristics of different signals. For example, a laser range finder may be provided in the first device and emit a laser signal, and the test distance may be determined based on a time difference of the laser signal received by the second device. As another example, the influence of smoke, dust, obstacles, etc., can be overcome based on the good penetration characteristics of the millimeter wave such that the test distance determined based on the signal intensity of the millimeter wave received by the second device is more accurate.

It should be noted that the process for determining the test distance may be combined accordingly. For example, a suitable process for determining the test distance may be determined according to the environment (e.g., noise) where the devices are located, the structure (e.g., obstacles such as walls) of an arrangement site, the distance between the devices, the test cost, etc., which is not limited in the present disclosure.

According to some embodiments of the present disclosure, the test distance between any two sound devices is determined based on various different signals, which makes the obtained test distance more accurate.

According to some embodiments of the present disclosure, the distances between the plurality of sound devices are determined based on the receiving intensity of the signal sent by the first device to the plurality of second devices, so as to automatically and accurately obtain the relative distances between the actual arranged devices, thereby improving the test efficiency, and reducing the consumption of manpower and material resources caused by manual distance measurement.

FIG. 7 is flowchart illustrating an exemplary process for determining a position correspondence between a plurality of point positions and a plurality of sound devices according to some embodiments of the present disclosure. In some embodiments, a process 700 may be performed by the second determination module 230.

In 710, a position correspondence between at least a portion of a plurality of point positions and at least a portion of a plurality of sound devices may be determined based on a plurality of first feature vectors and a plurality of second feature vectors whose similarities satisfy a first preset condition.

The first preset condition is a condition that the similarities between the plurality of first feature vectors and the plurality of second feature vectors needs to satisfy. For example, the first preset condition may include that the similarities between the plurality of first feature vectors and the plurality of second feature vectors is less than or equal to a preset similarity threshold.

In some embodiments, if the similarity between the first feature vector corresponding to a certain point position and the second feature vector corresponding to a certain sound device satisfies the first preset condition, the position correspondence between the point position and the sound device is determined. In this way, the position correspondence between at least a portion of the plurality of point positions and at least a portion of the plurality of sound devices may be determined.

In some embodiments, in the process 400, when calculating the similarity between the first feature vector corresponding to one point position and each of the plurality of second feature vectors corresponding to the plurality of sound devices, if the similarities between the plurality of second feature vectors and the first feature vector is less than the similarity threshold, the point position cannot accurately correspond to a unique sound device. A point position of which the corresponding sound device cannot be determined is taken as a pending point position. Similarly, a sound device of which the corresponding point position cannot be determined is taken as a pending sound device.

The pending point position refers to a point position whose correspondence to the sound device is not determined. For example, the pending point position may be a point position A, a point position C, a point position E, and a point position F among the plurality of point positions on a design drawing.

The pending sound device refer to a sound device whose correspondence to the point position is not determined. For example, the pending sound device may be a sound device 1, a sound device 3, a sound device 6, a sound device 10, etc. among the plurality of sound devices pre-planned for arrangement. The numbers of the sound devices may be in various other forms, which are only examples and not limiting.

It should be noted that after the second determination module 230 performs the process 400, there may be a plurality of pending point positions. For example, if the correspondence of 14 point positions of the 20 point positions on the design drawing to the corresponding sound devices is determined, and the correspondence of the remaining 6 point positions to the corresponding sound devices is not determined, the count of the pending point positions is 6.

In some embodiments, the pending point positions and the pending sound devices may be marked and further analyzed and processed to determine the correspondence between the pending point positions and the pending sound devices. For example, the correspondence between the pending point positions and the pending sound devices may be determined or corrected manually. More descriptions regarding manually determining the correspondence between the pending point positions and the pending sound devices may be found in FIG. 4 and the related descriptions thereof. In some embodiments, the correspondence between the pending point positions and the pending sound devices may be determined based on a preset algorithm.

In 720, in response to determining that a count of pending point positions or pending sound devices is greater than a preset count threshold, a plurality of initial pairing schemes may be generated based on a preset coding rule.

The preset count threshold may be a preset count of point positions or sound devices, such as 15, 20, etc. The preset count threshold may also be determined based on a ratio of the count of the pending point potions or the pending sound devices to a total count of point positions or sound devices. For example, the ratio may be set to 0.5, and when the total count of point positions or sound devices is 20, the preset count threshold is N=20*0.5=10.

The preset coding rule refers to a rule for characterizing the pairing or binding of a pending point position with a pending sound device. The coding rule may be expressed in various forms, such as binary coding, symbol coding, etc. For example, for the pending point positions A, B, C, D, and E, and the pending sound devices 1, 2, 3, 4, and 5, the coding rule may adopt the symbol coding, and first to fifth elements may represent the pending points A, B, C, D, and E, respectively, and the pairing scheme may be coded as (A1, B2, C3, D4, E5), where A1 indicates that the point position A is paired with the sound device 1, B2 indicates that the point position B is paired with the sound device 2, C3 indicates that the point position C is paired with the sound device 3, and so on.

The initial pairing scheme refers to an initially generated scheme for determining the correspondence between the point positions and the sound devices. In some embodiments, the second determination module 230 may determine a plurality of combination schemes for pairing the point positions with the sound devices based on the preset coding rule. The initial pairing schemes refers to the initially generated schemes among a plurality of pairing schemes generated based on the preset coding rule. In some embodiments, the second determination module 230 may randomly generate a plurality of initial pairing schemes based on the coding rule. For example, three different initial pairing schemes may be randomly generated, including (A1, B2, C3, D4, E5), (A2, B1, C3, D4, E5), (C3, D2, E1, A4, B5), etc.

In 730, an optimal pairing scheme may be determined by performing, based on a preset algorithm, a plurality of iterations to update the plurality of initial pairing schemes.

The preset algorithm refers to a preset analysis method for determining the pending point positions and the pending sound devices. For example, a plurality of pairing schemes may be generated based on permutations and combinations of pairing relationships between the pending point positions and the pending sound devices, the plurality of pairing schemes may be analyzed one by one to determine the optimal pairing scheme, and the correspondence between the pending point positions and the pending sound devices may be determined based on the optimal pairing scheme.

A condition for terminating the plurality of iterations may be that a second preset condition is satisfied. The second preset condition may include a plurality of conditions. For example, the second preset condition may be that a count of iterations is greater than a preset maximum count of iterations. As another example, the second preset condition may be that a maximum evaluation value of the scheme reaches a preset expected value (e.g., 1, 0.98). As another example, the second preset condition may be that the maximum evaluation value of the scheme remains constant for n iterations, or a difference between the maximum evaluation values of two consecutive iterations is less than a preset difference threshold. It should be noted that the second preset condition may be one or more combinations of the above, which is not limited in the present disclosure.

First candidate pairing schemes refer to initial candidate pairing schemes at the beginning of each iteration. In a first iteration, the first candidate pairing schemes may be a plurality of initial pairing schemes randomly generated by the second determination module 230. In subsequent iterations, the first candidate pairing schemes may be third candidate pairing schemes of a previous iteration.

In some embodiments, a current iteration of the plurality of iterations may include determining an evaluation value of each of first candidate pairing schemes. When the current iteration is the first iteration among the plurality of iterations, the first candidate pairing schemes are the plurality of initial pairing schemes; and when the iteration is not the first iteration, the first candidate pairing schemes are determined based on the third candidate pairing schemes of the previous iteration. The third candidate pairing schemes may be determined by performing a transformation operation on second candidate pairing schemes.

The evaluation value refers to a value used to determine whether each candidate pairing scheme satisfies the requirements. For example, the evaluation value may be a numerical value in an interval of [0, 1], and the greater the value, the more the corresponding candidate pairing scheme satisfies the requirements.

In some embodiments, the evaluation value may be determined based on various preset rules. For example, the evaluation value may be determined based on a preset evaluation function.

In some embodiments, the evaluation value of each of the candidate pairing schemes may be determined based on a matching degree between the plurality of point positions and the plurality of sound devices in the candidate pairing scheme based on the evaluation function. For example, the evaluation value may be determined by determining placement similarities between the plurality of point positions and the plurality of sound devices in each of the candidate pairing schemes based on the evaluation function. The placement similarity may be positively correlated with the evaluation value. That is, the greater the value of the placement similarity, the greater the evaluation value, and the more the corresponding candidate pairing scheme satisfies the requirements.

In some embodiments, the placement similarity may be determined based on a vector distance between the first feature vector corresponding to each point position and the second feature vector corresponding to a sound device to be paired in each candidate pairing scheme. For example, for a candidate pairing scheme (A1, B2, C3, D4, E5), the similarity calculation is performed based on the first feature vector corresponding to the point position A and the second feature vector corresponding to the sound device 120-1 to obtain a similarity s1 corresponding to the point position A. Similarly, the first feature vectors corresponding to the point positions B, C, D, and E are obtained respectively, and the similarity calculation is performed on the first feature vectors corresponding to the point positions B, C, D, and E and the second feature vectors corresponding to the sound device 120-1, the sound device 120-2, the sound device 120-3, the sound device 120-4, and the sound device 120-5, respectively, to obtain similarities s2, s3, s4, and s5 corresponding to the point positions B, C, D, and E. The placement similarity of the candidate pairing scheme is a sum of the similarities s1, s2, s3, s4, and s5. The placement similarity may also be a sum of similarities greater than the similarity threshold. More descriptions regarding the first feature vector and the second feature vector may be found in FIG. 4 and the related descriptions thereof.

The second candidate pairing schemes refers to a plurality of pairing schemes selected from the first candidate pairing schemes. For example, the second candidate pairing schemes may be (A2, B1, C3, D4, E5) and (A3, B2, C1, D4, E5) among the first candidate schemes (A1, B2, C3, D4, E5), (A2, B1, C3, D4, E5), (A3, B2, C1, D4, E5).

In some embodiments, the second determination module 230 may determine the second candidate pairing schemes based on a probability of each of the first candidate pairing schemes being selected through a preset selection function. The selection function may be various preset selection operators. For example, the selection function may be determined based on a roulette selection operator, an expected value selection operator, a uniform sorting operator, etc.

In some embodiments, the probability that each of the first candidate pairing schemes is selected as the second candidate pairing scheme may be determined based on a ratio of the evaluation value of each of the first candidate pairing schemes to a total evaluation value. The total evaluation value is a sum of the evaluation values of the first candidate pairing schemes. The larger the ratio of the evaluation value of the candidate pairing scheme to the total evaluation value, the larger the probability that the candidate pairing scheme is selected.

The third candidate pairing schemes refer to candidate pairing schemes generated based on the second candidate pairing schemes. The third candidate pairing schemes may include the second candidate pairing schemes and new candidate pairing schemes generated based on the second candidate pairing schemes.

In some embodiments, the second determination module 230 may determine the third candidate pairing schemes by performing the transformation operation on the second candidate pairing schemes.

The transformation operation refers to an operation of processing a candidate pairing scheme to generate a new candidate pairing scheme. For example, the transformation operation may include recombining and pairing point positions and/or sound devices in a candidate pairing scheme.

In some embodiments, the transformation operation may include a first transformation and a second transformation.

The first transformation may include selecting two second candidate pairing schemes from the second candidate pairing schemes, exchanging position correspondences between one or more of the plurality of point positions and the plurality of sound devices in the two second candidate pairing schemes, and modifying device duplication caused by the exchange to generate the third candidate pairing schemes.

It should be noted that the point positions and o the sound devices have a one-to-one correspondence. When the position correspondences between one or more of the plurality of point positions and the plurality of sound devices in the two second candidate pairing schemes exchange, the device duplication may be caused. Accordingly, the device duplication caused by the exchange needs to be modified.

For example, for two candidate pairing schemes (A1, B2, C3, D4, E5) and (A2, B1, C5, D3, E4), when the sound device 1 and the sound device 2 are exchanged, the two candidate pairing schemes become (A2, B2, C3, D4, E5) and (A1, B1, C3, D4, E5). It can be seen that A2 and B2 in one of the candidate pairing schemes are repeated in the sound device 2; and A1 and B1 in the other of the candidate pairing schemes are repeated in the sound device 1. In this case, the second determination module 230 may exchange the repeated sound devices to generate (A2, B1, C3, D4, E5) and (A1, B2, C5, D3, E4).

It should be noted that after the third candidate pairing schemes are generated based on the second candidate pairing schemes through the first transformation, the second determination module 230 may further process the third candidate pairing schemes through the evaluation function to obtain an evaluation value of each of the third candidate pairing schemes, and perform the next iteration. It can be understood that the higher the evaluation value of the third candidate pairing scheme, the greater the probability that the third candidate pairing scheme is selected for the first transformation in the next iteration.

The second transformation may include adjusting the position correspondences between one or more of the plurality of point positions and the plurality of sound devices in the second candidate pairing schemes to generate the third candidate pairing schemes.

In some embodiments, for a pairing scheme generated through the first transformation, the second determination module 230 may exchange position relationships of two sound devices in the pairing scheme through the second transformation. For example, for (A2, B1, C3, D4, E5) generated through the first transformation, the second determination module 230 may exchange the sound device 3 and the sound device 5 to generate a third candidate pairing scheme (A2, B1, C5, D4, E3).

In some embodiments, when the second transformation is performed, two sound devices exchanged in a target pairing scheme may be determined based on a similarity relationship between the second feature vectors corresponding to the two sound devices and the first feature vectors corresponding to pairing point positions. For example, the second determination module 230 may calculate the similarity between the second feature vector corresponding to each of the sound devices in the pairing scheme and the first feature vector corresponding to the paring point position, and select two sound devices corresponding to two closest similarities (e.g., two similarities with the smallest difference) for the second transformation.

In some embodiments, for each of the iterations, the second determination module 230 may compare the evaluation values of the third candidate pairing schemes generated after the first transformation and/or the second transformation with the evaluation values of the initial pairing schemes, and remove pairing schemes with relatively low evaluation values.

According to some embodiments of the present disclosure, the third candidate pairing schemes are generated through the first transformation and the second transformation, which can improve the efficiency of iteration and obtain the optimal pairing scheme more quickly.

The optimal pairing scheme refers to a candidate pairing scheme with the highest matching degree (e.g., the pairing scheme with the highest evaluation value) between the pending point positions and the pending sound devices.

In some embodiments, the second determination module 230 may determine the optimal pairing scheme from the third candidate pairing schemes obtained through the plurality of iterations.

In some embodiments, the second determination module 230 may take the third candidate pairing scheme with the largest evaluation value as the optimal pairing scheme from the third candidate pairing schemes obtained through the plurality of iterations after the second preset condition is satisfied.

According to some embodiments of the present disclosure, the plurality of candidate pairing schemes are obtained through the plurality of iterations, such that the candidate pairing schemes are gradually optimized, and finally the optimal pairing scheme is obtained.

In some embodiments, the second determination module 230 may screen the third candidate pairing schemes based on the evaluation values of the third candidate pairing schemes, and use the screened third candidate pairing schemes as the first candidate pairing schemes of the next iteration or for determining the optimal pairing scheme.

In some embodiments, the second determination module 230 may compare the evaluation values of the third candidate pairing schemes and remove the pairing schemes with relatively low evaluation values.

According to some embodiments of the present disclosure, the range of the target pairing scheme can be reduced by screening and removing the candidate pairing schemes with relatively low evaluation values, thereby improving processing efficiency, reducing the computational burden of processing devices, and improving the efficiency of the next iteration.

In 740, the position correspondence between the pending point positions and the pending sound devices may be determined based on the optimal pairing scheme.

In some embodiments, according to the optimal pairing scheme determined in the above operations, the second determination module 230 may perform decoding based on the coding rule to determine the correspondence between the plurality of pending point positions and the plurality of pending sound devices. For example, when the optimal pairing scheme is (A2, B4, C3, D5, E1), the sound devices corresponding to the point positions A, B, C, D, E on the design drawing are sound devices 2, 4, 5, 6, 1, respectively according to the pairing relationship between the pending points and the pending sound devices based on the coding rule.

According to some embodiments of the present disclosure, the optimal pairing scheme is determined based on a preset algorithm, and then the one-to-one correspondence between the plurality of pending points and the plurality of pending devices is determined, which can reduce the manpower and time costs caused by manual processing.

Having thus described the basic concepts, it may be rather apparent to those skilled in the art after reading this detailed disclosure that the foregoing detailed disclosure is intended to be presented by way of example only and is not limiting. Various alterations, improvements, and modifications may occur and are intended to those skilled in the art, though not expressly stated herein. These alterations, improvements, and modifications are intended to be suggested by this disclosure and are within the spirit and scope of the exemplary embodiments of this disclosure.

Moreover, certain terminology has been used to describe embodiments of the present disclosure. For example, the terms “one embodiment,” “an embodiment,” and “some embodiments” mean that a particular feature, structure, or feature described in connection with the embodiment is included in at least one embodiment of the present disclosure. Therefore, it is emphasized and should be appreciated that two or more references to “an embodiment” or “one embodiment” or “an alternative embodiment” in various portions of this specification are not necessarily all referring to the same embodiment. Furthermore, the particular features, structures, or features may be combined as suitable in one or more embodiments of the present disclosure.

Furthermore, the recited order of processing elements or sequences, or the use of numbers, letters, or other designations therefore, is not intended to limit the claimed processes and methods to any order except as may be specified in the claims. Although the above disclosure discusses through various examples what is currently considered to be a variety of useful embodiments of the disclosure, it is to be understood that such detail is solely for that purpose and that the appended claims are not limited to the disclosed embodiments, but, on the contrary, are intended to cover modifications and equivalent arrangements that are within the spirit and scope of the disclosed embodiments. For example, although the implementation of various parts described above may be embodied in a hardware device, it may also be implemented as a software only solution, e.g., an installation on an existing server or mobile device.

Similarly, it should be appreciated that in the foregoing description of embodiments of the present disclosure, various features are sometimes grouped together in a single embodiment, figure, or description thereof for the purpose of streamlining the disclosure aiding in the understanding of one or more of the various embodiments. This method of disclosure, however, is not to be interpreted as reflecting an intention that the claimed subject matter requires more features than are expressly recited in each claim. Rather, claimed subject matter may lie in less than all features of a single foregoing disclosed embodiment.

In some embodiments, numbers describing the number of ingredients and attributes are used. It should be understood that such numbers used for the description of the embodiments use the modifier “about”, “approximately”, or “substantially” in some examples. Unless otherwise stated, “about”, “approximately”, or “substantially” indicates that the number is allowed to vary by ±20%. Correspondingly, in some embodiments, the numerical parameters used in the description and claims are approximate values, and the approximate values may be changed according to the required features of individual embodiments. In some embodiments, the numerical parameters should consider the prescribed effective digits and adopt the method of general digit retention. Although the numerical ranges and parameters used to confirm the breadth of the range in some embodiments of the present disclosure are approximate values, in specific embodiments, settings of such numerical values are as accurate as possible within a feasible range.

For each patent, patent application, patent application publication, or other materials cited in the present disclosure, such as articles, books, specifications, publications, documents, or the like, the entire contents of which are hereby incorporated into the present disclosure as a reference. The application history documents that are inconsistent or conflict with the content of the present disclosure are excluded, and the documents that restrict the broadest scope of the claims of the present disclosure (currently or later attached to the present disclosure) are also excluded. It should be noted that if there is any inconsistency or conflict between the description, definition, and/or use of terms in the auxiliary materials of the present disclosure and the content of the present disclosure, the description, definition, and/or use of terms in the present disclosure is subject to the present disclosure.

Finally, it should be understood that the embodiments described in the present disclosure are only used to illustrate the principles of the embodiments of the present disclosure. Other variations may also fall within the scope of the present disclosure. Therefore, as an example and not a limitation, alternative configurations of the embodiments of the present disclosure may be regarded as consistent with the teaching of the present disclosure. Accordingly, the embodiments of the present disclosure are not limited to the embodiments introduced and described in the present disclosure explicitly.

What is claimed is:

1. A method for determining positions of sound devices, comprising:
acquiring first position information corresponding to a plurality of point positions, a plurality of sound devices being disposed at the plurality of point positions;
determining, based on signal transmitting and receiving data between the plurality of sound devices, second position information corresponding to the plurality sound devices; and
determining, based on the first position information and the second position information, a position correspondence between the plurality of point positions and the plurality of sound devices.

2. The method of claim 1, wherein
for each of the plurality of point positions, the first position information includes a plurality of first distances corresponding to the point position, the first distances being relative distances between the point position and other point positions; and
for each of the plurality of sound devices, the second position information includes a plurality of second distances corresponding to the sound device, the second distances being test distances between the sound device and other sound devices.

3. The method of claim 2, wherein the determining, based on the first position information and the second position information, a position correspondence between the plurality of point positions and the plurality of sound devices includes:
for each of the plurality of point positions, determining a first feature vector corresponding to the point position, elements in the first feature vector being determined based on the first distances;
for each of the plurality of sound devices, determining a second feature vector corresponding to the sound device, wherein elements in the second feature vector are determined based on the second distances, and the elements in a plurality of first feature vectors corresponding to the plurality of point positions and the elements in a plurality of second feature vectors corresponding to the plurality of sound devices are arranged in the same manner; and
determining, based on similarities between the plurality of first feature vectors and the plurality of second feature vectors, the position correspondence between the plurality of point positions and the plurality of sound devices.

4. The method of claim 3, wherein the determining, based on similarities between the plurality of first feature vectors and the plurality of second feature vectors, the position correspondence between the plurality of point positions and the plurality of sound devices includes:
determining, based on a plurality of first feature vectors and a plurality of second feature vectors whose similarities satisfy a first preset condition, a position correspondence between at least a portion of the plurality of point positions and at least a portion of the plurality of sound devices;
determining point positions and sound devices whose position correspondence has not been determined as pending point positions and pending sound devices, respectively;
in response to determining that a count of the pending point positions or the pending sound devices is greater than a preset count threshold, generating a plurality of initial pairing schemes based on a preset coding rule;
determining an optimal pairing scheme by performing, based on a preset algorithm, a plurality of iterations to update the plurality of initial pairing schemes; and
determining, based on the optimal pairing scheme, the position correspondence between the pending point positions and the pending sound devices.

5. The method of claim 4, wherein a current iteration of the plurality of iterations includes:
determining an evaluation value of each of first candidate pairing schemes, wherein when the current iteration is the first iteration among the plurality of iterations, the first candidate pairing schemes are the plurality of initial pairing schemes, and when the iteration is not the first iteration, the first candidate pairing schemes are determined based on third candidate pairing schemes of a previous iteration;
determining, based on a preset selection function, second candidate pairing schemes from the first candidate pairing schemes;
determining the third candidate pairing schemes by performing a transformation operation on the second candidate pairing schemes;
in response to determining that a second preset condition is not satisfied, proceeding to a next iteration; or in response to determining that the second preset condition is satisfied, determining the optimal pairing solution from the third candidate pairing schemes.

6. The method of claim 5, wherein the first candidate pairing schemes are determined based on the third candidate pairing schemes of the previous iteration by:
screening the third candidate pairing schemes of the previous iteration based on evaluation values of the third candidate pairing schemes of the previous iteration, and
using the screened third candidate pairing schemes as the first candidate pairing schemes.

7. The method of claim 5, wherein the transformation operation includes a first transformation and a second transformation,
the first transformation includes:
selecting two second candidate pairing schemes from the second candidate pairing schemes,
exchanging position correspondences between one or more of the plurality of point positions and the plurality of sound devices in the two second candidate pairing schemes, and
modifying device duplication caused by the exchange to generate the third candidate pairing schemes; and
the second transformation includes: adjusting the position correspondences between one or more of the plurality of point positions and the plurality of sound devices in the second candidate pairing schemes to generate the third candidate pairing schemes.

8. The method of claim 5, wherein the second preset condition includes at least one of: a count of the plurality of iterations is greater than a preset maximum count of iterations, a maximum evaluation value reaches a preset expected value, the maximum evaluation value remains constant for n iterations, or a difference between the maximum evaluation values of two consecutive iterations is less than a preset difference threshold.

9. The method of claim 1, wherein the determining, based on signal transmitting and receiving data between the plurality of sound devices, second position information corresponding to the plurality of sound devices includes:
for any two sound devices of the plurality of sound devices, determining, based on a receiving intensity of a signal sent by one of the two sound devices to the other sound device, a test distance between the two sound devices as the second position information.

10. The method of claim 9, wherein
the sound device that sends the signal is taken as a first device, and the sound device that receives the signal is taken as a second device, and the signal includes sound waves of a plurality of frequencies; and the determining the test distance between the two sound devices includes:
causing the first device to transmit the sound waves of the plurality of frequencies; and
determining, based on the receiving intensity of the sound waves of the plurality of frequencies, the test distance using the second device.

11. The method of claim 10, wherein the signal includes at least one of a laser beam and a millimeter wave.

12. A system for determining positions of sound devices, comprising:
an acquisition module configured to acquire first position information corresponding to a plurality of point positions, a plurality of sound devices being disposed at the plurality of point positions;
a first determination module configured to determine, based on signal transmitting and receiving data between the plurality of sound devices, second position information corresponding to the plurality of sound devices; and
a second determination module configured to determine, based on the first position information and the second position information, a position correspondence between the plurality of point positions and the plurality of sound devices.

13. The system of claim 12, wherein
for each of the plurality of point positions, the first position information includes a plurality of first distances corresponding to the point position, the first distances being relative distances between the point position and other point positions; and
for each of the plurality of sound devices, the second position information includes a plurality of second distances corresponding to the sound device, the second distances being test distances between the sound device and other sound devices.

14. The system of claim 13, wherein the second determination module is further configured to:
for each of the plurality of point positions, determine a first feature vector corresponding to the point position, elements in the first feature vector being determined based on the first distances;
for each of the plurality of sound devices, determine a second feature vector corresponding to the sound devices, wherein elements in the second feature vector are determined based on the second distances, and the elements in a plurality of first feature vectors corresponding to the plurality of point positions and the elements in a plurality of second feature vectors corresponding to the plurality of sound devices are arranged in the same manner; and
determine, based on similarities between the plurality of first feature vectors and the plurality of second feature vectors, the position correspondence between the plurality of point positions and the plurality of sound devices.

15. The system of claim 13, wherein the first determination module is further configured to:
for any two sound devices of the plurality of sound devices, determine, based on a receiving intensity of a signal sent by one of the two sound devices to the other sound device, a test distance between the two sound devices as the second position information.

16. The system of claim 15, wherein
the sound device that sends the signal is taken as a first device, and the sound device that receives the signal is taken as a second device, and the signal includes sound waves of a plurality of frequencies; and the first determination module is further configured to:
cause the first device to transmit the sound waves of the plurality of frequencies; and
determine, based on the receiving intensity of the sound waves of the plurality of frequencies, the test distance using the second device.

17. A non-transitory computer-readable storage medium, comprising computer instructions that, when read by a computer, direct the computer to execute a method for determining positions of sound devices, the method comprising:
acquiring first position information corresponding to a plurality of point positions, a plurality of sound devices being disposed at the plurality of point positions;
determining, based on signal transmitting and receiving data between the plurality of sound devices, second position information corresponding to the plurality sound devices; and
determining, based on the first position information and the second position information, a position correspondence between the plurality of point positions and the plurality of sound devices.

18. The non-transitory computer-readable storage medium of claim 17, wherein
for each of the plurality of point positions, the first position information includes a plurality of first distances corresponding to the point position, the first distances being relative distances between the point position and other point positions; and
for each of the plurality of sound devices, the second position information includes a plurality of second distances corresponding to the sound device, the second distances being test distances between the sound device and other sound devices.

19. The non-transitory computer-readable storage medium of claim 18, wherein the determining, based on the first position information and the second position information, a position correspondence between the plurality of point positions and the plurality of sound devices includes:
for each of the plurality of point positions, determining a first feature vector corresponding to the point position, elements in the first feature vector being determined based on the first distances;
for each of the plurality of sound devices, determining a second feature vector corresponding to the sound device, wherein elements in the second feature vector are determined based on the second distances, and the elements in a plurality of first feature vectors corresponding to the plurality of point positions and the elements in a plurality of second feature vectors corresponding to the plurality of sound devices are arranged in the same manner; and
determining, based on similarities between the plurality of first feature vectors and the plurality of second feature vectors, the position correspondence between the plurality of point positions and the plurality of sound devices.

20. The non-transitory computer-readable storage medium of claim 19, wherein the determining, based on similarities between the plurality of first feature vectors and the plurality of second feature vectors, the position correspondence between the plurality of point positions and the plurality of sound devices includes:
determining, based on a plurality of first feature vectors and a plurality of second feature vectors whose similarities satisfy a first preset condition, a position correspondence between at least a portion of the plurality of point positions and at least a portion of the plurality of sound devices;
determining point positions and sound devices whose position correspondence has not been determined as pending point positions and pending sound devices, respectively;
in response to determining that a count of the pending point positions or the pending sound devices is greater than a preset count threshold, generating a plurality of initial pairing schemes based on a preset coding rule;
determining an optimal pairing scheme by performing, based on a preset algorithm, a plurality of iterations to update the plurality of initial pairing schemes; and
determining, based on the optimal pairing scheme, the position correspondence between the pending point positions and the pending sound devices.
